(19) United States
(12) Patent Application Publication
(10) Pub. No.: US 2017/0153208 A1
(43) Pub. Date: Jun. 1, 2017

(54) Method Of Deriving Natural Frequency Of Cutting Tool, Method Of Creating Stability Limit Curve, And Apparatus For Deriving Natural Frequency Of Cutting Tool

(71) Applicant: DMG MORI CO., LTD., Nara (JP)

(72) Inventors: Kengo Kawai, Nara (JP); Katsuhiko Ono, Nara (JP); Shizuo Nishikawa, Nara (JP)

(73) Assignee: DMG MORI CO., LTD., Nara (JP)

(21) Appl. No.: 15/345,971

(22) Filed: Nov. 8, 2016

(30) Foreign Application Priority Data
Nov. 26, 2015 (JP) 2015-230466

(51) Int. Cl. G01N 29/44; G01N 29/04; B23Q 17/09

(52) U.S. Cl. CPC G01N 29/449; B23Q 17/0971; G01N 29/045; G01N 2291/014

(57) ABSTRACT

An apparatus includes a machining executing part causing a machine tool to execute an operation of, while changing a spindle rotation speed of the machine tool in a stepwise manner, machining a workpiece by a predetermined distance or for a predetermined period of time at each spindle rotation speed, a displacement detector detecting a position displacement of a tool during the machining, a cutting force detector detecting a cutting force applied to the tool, a frequency analysis part performing frequency analysis on displacement data and cutting force data for each rotation speed to calculate a displacement spectrum and a cutting force spectrum, and a natural frequency deriving part calculating a compliance spectrum for each spindle rotation speed by deriving the displacement spectrum by the cutting force spectrum, calculating an integrated compliance spectrum by superimposing the compliance spectra, and deriving, as a natural frequency, a frequency showing the largest compliance value.

### BACKGROUND

Field of the Disclosure

The present disclosure relates to a method of deriving a natural frequency of a cutting tool used in machining an object to be machined (workpiece) with a machine tool and a method of creating a stability limit curve concerning regenerative chatter of the cutting tool, as well as an apparatus for deriving the natural frequency of the cutting tool.

Background of the Disclosure

In machining a workpiece with a machine tool, it has been well known that machining accuracy (in particular, surface accuracy) is impaired by chatter vibration. Such chatter vibration is roughly classified into forced chatter vibration and self-exited chatter vibration, and forced chatter vibration is considered to occur when an excessive external force is applied or when a frequency of an external force is synchronized with a resonance frequency of a vibrating system. On the other hand, self-exited chatter vibration includes regeneration type chatter vibration (regenerative chatter vibration) and mode-coupling type chatter vibration. Regenerative chatter vibration is considered to be caused by continuing cutting in which periodic variation of cutting resistance and periodic variation of thickness of cut are increased by interaction between them (the so-called “regeneration effect”); mode-coupling type chatter vibration is considered to be caused by coupling of vibration modes in two directions when resonance frequencies of the vibration modes are close to each other.

As a method of suppressing regenerative chatter vibration that is one of the above-mentioned various types of chatter vibration, there has been proposed a method in which a stability limit curve (diagram showing a stability limit in depth of cut with respect to spindle rotation speed) is obtained and a spindle rotation speed is adjusted so that it is positioned in a stable area (see Japanese Unexamined Patent Application Publication No. 2012-213830).

For creating such a stability limit curve, data such as a natural frequency of the tool and a damping ratio, an equivalent mass, a cutting rigidity, and a specific cutting rigidity of the machining system are required. The damping ratio and the equivalent mass can be calculated from the natural frequency of the tool; therefore, both the damping ratio and the equivalent mass can be calculated if the natural frequency of the tool is obtained. As a method for deriving the natural frequency of the tool, there has been generally known a method in which a tip end portion of the tool is struck using an impact hammer and the natural frequency of the tool is derived based on data on free vibration of the tool obtained at the time of striking and data on a striking force of the impact hammer (see Japanese Unexamined Patent Application Publication No. 2014-14882).

Further, the cutting rigidity and the specific cutting rigidity can be calculated based on, for example, a value of a current that flows in a spindle motor when machining is actually performed using the tool.

### SUMMARY OF THE DISCLOSURE

However, in the conventional method that uses an impact hammer to derive a natural frequency of a cutting tool, artificial variation is likely to occur because the striking using the impact hammer is performed by a human. Therefore, the conventional method has a problem that it is difficult to obtain an accurate natural frequency of the cutting tool and a problem that technical skills are required in the striking per se in order to obtain appropriate data.

Further, as for a hammer tip attached to the striking portion of the impact hammer, a period of a vibration frequency to be measured (the reciprocal of the frequency) has to be calculated and a hammer tip has to be selected through trial and error so that contact time of the hammer is within a range of about 0.3 to one times the period; therefore, there is also a problem that the selecting operation is very cumbersome.

Furthermore, according to knowledge of the inventors, it is conceivable that the values of a natural frequency of a cutting tool in machining time during which the cutting tool is actually machining a workpiece and in free time during which the cutting tool is not machining a workpiece are slightly different. Therefore, if a natural frequency of a cutting tool can be derived based on a state of actually machining a workpiece, it is possible to derive a more accurate natural frequency which takes into account influence of the workpiece.

The present disclosure has been achieved in view of the above-described circumstances and an object thereof is to provide a method and an apparatus which are capable of deriving a more accurate natural frequency of a cutting tool without causing artificial variation and without requiring a cumbersome operation or special technical skills, as well as a method of creating a stability limit curve.

The present disclosure, for solving the above-described problems, relates to a method of deriving a natural frequency of a cutting tool used in machining an object to be machined with a machine tool, including:

an actual machining step of, while changing a rotational speed of a spindle of the machine tool in a stepwise manner, machining the object to be machined with the cutting tool by a predetermined distance or for a predetermined period of time at each rotational speed;

a detecting step of, during the actual machining step, detecting a position displacement occurring on the cutting tool and detecting a cutting force applied to the cutting tool;

an analyzing step of performing frequency analysis on displacement data and cutting force data for each rotational speed of the spindle obtained in the detecting step to obtain a displacement spectrum and a cutting force spectrum; and

a deriving step of,

calculating, based on the displacement spectrum and the cutting force spectrum for each rotational speed of the spindle obtained in the analyzing step, a compliance spectrum for each rotational speed by dividing the displacement spectrum by the cutting force spectrum,

calculating an integrated compliance spectrum by superimposing the calculated compliance spectra, and

deriving, as a natural frequency of the cutting tool, a frequency showing the largest compliance value from the calculated integrated compliance spectrum.

Further, this natural frequency deriving method can be suitably carried out by an apparatus for deriving a natural frequency of a cutting tool used in machining an object to be machined with a machine tool, the apparatus including:

a machining executing part that causes the machine tool to execute an operation of, while changing a rotational speed of a spindle of the machine tool in a stepwise manner, machining the object to be machined by a predetermined distance or for a predetermined period of time at each rotational speed;

a displacement detector that detects a position displacement occurring on the cutting tool during the execution of machining by the machine tool;

a cutting force detector that detects a cutting force applied to the cutting tool during the execution of machining by the machine tool;

a frequency analysis part that performs frequency analysis on displacement data and cutting force data for each rotational speed of the spindle obtained by the displacement detector and the cutting force detector to obtain a displacement spectrum and a cutting force spectrum; and

a natural frequency deriving part that

calculates, based on the displacement spectrum and the cutting force spectrum for each rotational speed of the spindle obtained in the frequency analysis part, a compliance spectrum for each rotational speed by dividing the displacement spectrum by the cutting force spectrum,

calculates an integrated compliance spectrum by superimposing the calculated compliance spectra, and

derives, as a natural frequency of the cutting tool, a frequency showing the largest compliance value from the calculated integrated compliance spectrum.

In the method and apparatus according to the present disclosure that derive a natural frequency of a cutting tool, first, the machining executing part causes the machine tool to operate so as to, while changing a rotational speed of a spindle of the machine tool in a stepwise manner, machine the object to be machined with the cutting tool by a predetermined distance or for a predetermined period of time at each rotational speed (actual machining step). During the actual machining being performed, the displacement detector and the cutting force detector detect a position displacement occurring on the cutting tool and a cutting force applied to the cutting tool, respectively (detecting step). Note that the stepwise change of the rotational speed of the spindle means changing the rotational speed of the spindle in a pulsed manner or a stepped manner, and the rotational speed of the spindle is constant while the object to be machined is being machined by the predetermined distance or for the predetermined period of time. Further, the amount of the stepwise change of the rotational speed of the spindle is not particularly limited and is set as appropriate taking into consideration accuracy and efficiency of data obtaining.

Subsequently, the frequency analysis part performs frequency analysis (FFT) on displacement data and cutting force data for each rotational speed of the spindle obtained by the displacement detector and the cutting force detector to calculate spectra (waveforms) for the displacement and the cutting force (analyzing step). Note that the obtained displacement spectrum and cutting force spectrum each show different characteristics, that is, peak frequencies, in accordance with the rotational speed of the spindle.

Subsequently, based on the obtained displacement spectrum and cutting force spectrum for each rotational speed, the natural frequency deriving part first calculates a compliance spectrum for each rotational speed that is obtained by dividing the displacement spectrum by the cutting force spectrum, and then calculate an integrated compliance spectrum that is obtained by superimposing all of the compliance spectra obtained for the rotational speeds (deriving step). Note that “compliance” herein is a ratio between the cutting force as input and the displacement as output thereto and is defined as an input-to-output transfer function.

Thereafter, based on the calculated integrated compliance spectrum, the natural frequency deriving part analyzes the integrated compliance spectrum and thereby derives, as a natural frequency of the cutting tool, a frequency showing the largest compliance value (deriving step). As described above, the compliance expresses [displacement (=output)/cutting force (=input)]. Therefore, a frequency showing the largest compliance value, that is, a frequency with the largest output to the input can be designated as a natural frequency of the cutting tool.

Thus, according to the present disclosure, an object to be machined is actually machined using a cutting tool whose natural frequency needs to be derived, and a natural frequency of the cutting tool is derived based on a displacement of the cutting tool and a cutting force applied to the cutting tool that are detected during the actual machining. Therefore, it is possible to derive a more accurate natural frequency that takes into account influence of the object to be machined the cutting tool receives in actual machining.

Further, an impact hammer, which is used in the conventional method, is not used. Therefore, in deriving a natural frequency of the cutting tool, the problem of artificial variation does not occur, technical skills are not required for obtaining appropriate data, and the cumbersome operation of selecting a hammer tip is also not required.

In addition, the present disclosure relates to a stability limit curve creating method including:

the above-described steps for deriving a natural frequency of a cutting tool; and

a curve creating step of calculating a damping ratio and an equivalent mass of a machining system including at least the cutting tool and the object to be machined based on the integrated compliance spectrum obtained in the deriving step and the natural frequency of the cutting tool, and creating a stability limit curve concerning regenerative chatter of the cutting tool based on the obtained damping ratio and equivalent mass and the natural frequency.

According to this stability limit curve creating method, because, as described above, it is possible to derive a more accurate natural frequency that conforms to actual machining situation such as influence of the object to be machined the cutting tool receives in actual machining, a stability limit curve created based on such a natural frequency will be an accurate stability limit curve that better conforms to actual machining situation.

Further, in this stability limit curve creating method,

the deriving step may be configured to derive, as natural frequencies of the cutting tool, at least two frequencies showing a maximal compliance value in decreasing order of the compliance value based on the integrated compliance spectrum, and

the curve creating step may be configured to calculate, based on the integrated compliance spectrum calculated in the deriving step and the natural frequencies of the cutting tool, a damping ratio and an equivalent mass of a machining system including at least the cutting tool and the object to be machined corresponding to each of the natural frequencies, and create, based on the obtained damping ratios and equivalent masses and the natural frequencies, a stability limit curve concerning regenerative chatter of the cutting tool corresponding to each of the natural frequencies.

In this configuration, a stability limit curve is created for each of a plurality of possible natural frequencies of the cutting tool; therefore, setting actual machining conditions with reference to such stability limit curves achieves a more stable machining in which regenerative chatter is more unlikely to occur.

Further, in the natural frequency deriving apparatus and natural frequency deriving method according to the present disclosure,

the machining executing part may be configured to, in the actual machining step, while changing a rotational speed of the spindle in a stepwise manner, at each rotational speed, machine the object to be machined by a predetermined distance or for a predetermined period of time by relatively moving the cutting tool with respect to the object to be machined through independent operations of a first axis and a second axis as two feed axes perpendicular to the spindle and perpendicular to each other or through a combined operation of the first axis and the second axis so that feed components for directions of the first axis and the second axis are contained,

the displacement detector may be configured to, in the detecting step, detect a position displacement occurring on the cutting tool for each of the feed directions of the first axis and the second axis at each rotational speed,

the cutting force detector may be configured to, in the detecting step, detect a cutting force applied to the cutting tool at each rotational speed,

the frequency analysis part may be configured to, in the analyzing step, perform frequency analysis on displacement data and cutting force data obtained for each of the feed directions at each rotational speed to obtain a displacement spectrum and a cutting force spectrum, and

the natural frequency deriving part may be configured to, in the deriving step,

for each of the feed directions, calculate a compliance spectrum for each rotational speed by dividing the displacement spectrum by the cutting force spectrum and calculate an integrated compliance spectrum by superimposing the calculated compliance spectra,

detect a frequency showing the largest compliance value from each of the calculated integrated compliance spectra, and

derive the two detected frequencies as natural frequencies of the cutting tool for the feed directions.

In this configuration, as described above, the object to be machined is machined by causing the machining executing part to relatively move the cutting tool with respect to the object to be machined so that feed components for the directions of the first axis and the second axis are contained. Note that examples of the manner in which the cutting tool is relatively moved with respect to the object to be machined include a manner such that the cutting tool is relatively moved in one of the feed directions with the rotational speed of the spindle being changed in a stepwise manner and then in the other of the feed directions similarly with the rotational speed of the spindle being changed in a stepwise manner, and a manner such that the cutting tool is relatively moved in a direction defined by combining the two feed directions through a combined operation of the first axis and the second axis with the rotational speed of the spindle being changed in a stepwise manner.

Further, the displacement detector detects a displacement occurring on the cutting tool for each of the feed directions at each rotational speed and the cutting force detector detects a cutting force applied to the cutting at each rotational speed, and the frequency analysis part performs frequency analysis on displacement data and cutting force data obtained for each of the feed directions at each rotational speed to calculate a displacement spectrum and a cutting force spectrum.

Further, the natural frequency deriving part calculates an integrated compliance spectrum for each of the feed directions, detects a frequency showing the largest compliance value from each of the calculated integrated compliance spectra, and derives the two detected frequencies as natural frequencies of the cutting tool for the feed directions.

Thus, according to this configuration, in the case where the machine tool has a first axis and a second axis as two feed axes that are perpendicular to a spindle and perpendicular to each other, it is possible to derive a natural frequency of the cutting tool for each of the feed directions, and therefore it is possible to derive a natural frequency of the cutting tool which better conforms to actual machining situation.

In addition, a stability limit curve creating method according to the present disclosure is configured to include the steps of this natural frequency deriving method, and a curve creating step of calculating a damping ratio and an equivalent mass of a machining system including at least the cutting tool and the object to be machined for each of the feed directions based on the integrated compliance spectra calculated in the deriving step and the natural frequencies of the cutting tools, and creating a stability limit curve concerning regenerative chatter of the cutting tool for each of the feed directions based on the calculated damping ratios and equivalent masses and the natural frequencies.

According to the thus configured stability limit curve creating method, it is possible to create a stability limit curve corresponding to a machine tool having a first axis and a second axis as two feed axes that are perpendicular to a spindle and perpendicular to each other.

Further, in this stability limit curve creating method,

the deriving step may be configured to derive, as natural frequencies of the cutting tool, at least two frequencies showing a maximal compliance value in decreasing order of the compliance value for each of the feed directions based on the integrated compliance spectrum calculated for the feed direction, and

the curve creating step may be configured to calculate a damping ratio and an equivalent mass of a machining system including at least the cutting tool and the object to be machined corresponding to each of the natural frequencies for each of the feed directions based on the integrated compliance spectrum for the feed direction calculated in the deriving step and the natural frequencies of the cutting tool for the feed direction, and create a stability limit curve concerning regenerative chatter of the cutting tool corresponding to each of the natural frequencies for each of the feed directions based on the calculated damping ratios and equivalent masses and the natural frequencies.

In this configuration, a stability limit curve is created for each of a plurality of possible natural frequencies of the cutting tool, and setting actual machining conditions with reference to such stability limit curves achieves a more stable machining in which regenerative chatter is more unlikely to occur.

Further, in the above stability limit curve creating method,

the curve creating step may be configured to calculate a damping ratio and an equivalent mass of a machining system including at least the cutting tool and the object to be machined for each of the feed directions based on the integrated compliance spectrum for the feed direction calculated in the deriving step and the natural frequency of the cutting tool for the feed direction, and create a stability limit curve concerning regenerative chatter of the cutting tool for a predetermined feed direction based on the calculated damping ratios and equivalent masses for the feed directions and the natural frequencies for the feed directions.

### Advantageous Effects of Disclosure

As described above, according to the present disclosure, an object to be machined is actually machined using a cutting tool whose a natural frequency needs to be derived, and the natural frequency of the cutting tool is derived based on a displacement of the cutting tool and a cutting force applied to the cutting tool that are detected during the actual machining; therefore, it is possible to derive a more accurate natural frequency that takes into account influence of the object to be machined the cutting tool receives in actual machining.

Further, an impact hammer, which is used in the conventional method, is not used. Therefore, in deriving a natural frequency of a cutting tool, the problem of artificial variation does not occur, technical skills are not required for obtaining appropriate data, and the cumbersome operation of selecting a hammer tip is also not required.

Furthermore, creating a stability limit curve based on the thus obtained natural frequency enables a more accurate stability limit curve that better conforms to actual machining situation.

### BRIEF DESCRIPTION OF THE DRAWINGS

FIG. 1 is a perspective view of a machine tool according to an embodiment of the present disclosure;

FIG. 2 is a block diagram showing a schematic configuration of a natural frequency deriving apparatus according to the embodiment;

FIG. 3 is an illustration showing a machining manner executed in a detection machining executing part according to the embodiment;

FIG. 4 is a spectrum waveform diagram showing a Y-axis direction displacement spectrum;

FIG. 5 is a spectrum waveform diagram showing a Y-axis direction cutting force spectrum;

FIG. 6 is a spectrum waveform diagram showing a Y-axis direction displacement spectrum after filtering;

FIG. 7 is a spectrum waveform diagram showing a Y-axis direction cutting force spectrum after filtering;

FIG. 8 is a spectrum waveform diagram showing a Y-axis direction compliance spectrum;

FIG. 9 is a spectrum waveform diagram showing superimposed Y-axis direction compliance spectra;

FIG. 10 is a spectrum waveform diagram showing a Y-axis direction integrated compliance spectrum;

FIG. 11 is a spectrum waveform diagram showing an X-axis direction integrated compliance spectrum;

FIG. 12 is an illustration showing a cutting model with two degrees of freedom;

FIG. 13 is an illustration for explaining calculation of a damping ratio; and

FIG. 14 is a diagram showing a stability limit curve.

### DETAILED DESCRIPTION

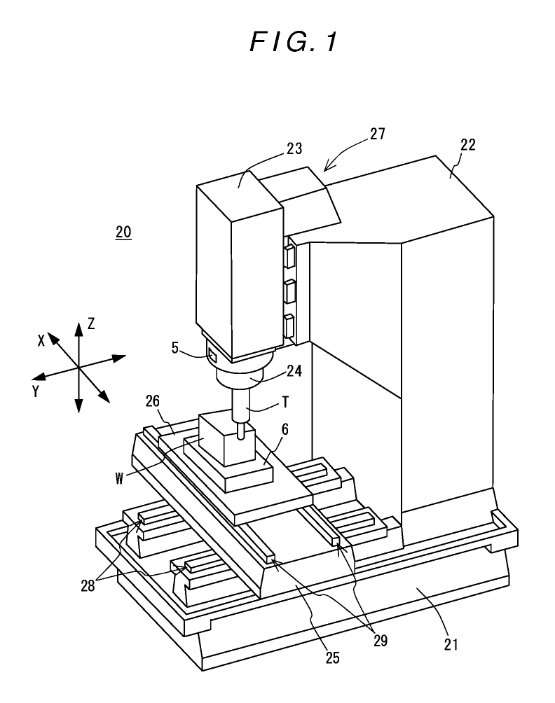

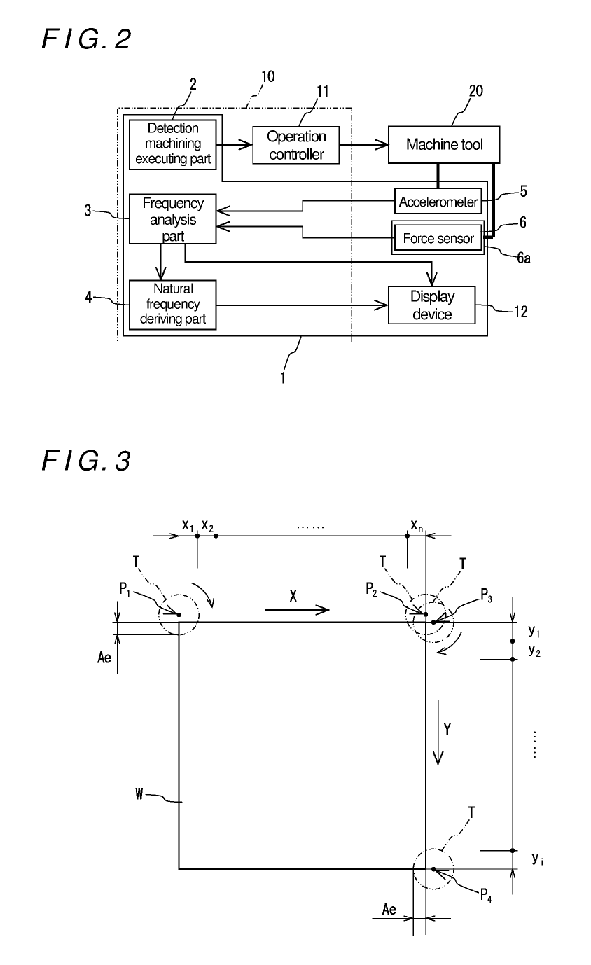

Hereinafter, a specific embodiment of the present disclosure will be described with reference to the drawings. FIG. 1 is a perspective view of a machine tool used in this embodiment and FIG. 2 is a block diagram showing a natural frequency deriving apparatus and other elements according to this embodiment.

### Schematic Configuration of Machine Tool

First of all, a machine tool 20 is schematically described. This machine tool 20 includes a bed 21, a column 22 erected on the bed 21, a spindle head 23 provided on a front surface (machining area side surface) of the column 22 to be movable in a direction of the Z axis indicated by arrow, a spindle 24 held by the spindle head 23 to be rotatable about an axis thereof, a saddle 25 provided on the bed 21 below the spindle head 23 to be movable in a direction of the Y axis indicated by arrow, a table 26 disposed on the saddle 25 to be movable in a direction of the X axis indicated by arrow, an X-axis feed mechanism 29 for moving the table 26 in the X-axis (first axis) direction, a Y-axis feed mechanism 28 for moving the saddle 25 in the Y-axis (second axis) direction, a Z-axis feed mechanism 27 for moving the spindle head 23 in the Z-axis (third axis) direction, and a spindle motor (not shown) rotating the spindle 24. Note that the X axis, the Y axis, and the Z axis are feed axes that are perpendicular to each other.

Note that operations of the X-axis feed mechanism 29, Y-axis feed mechanism 28, Z-axis feed mechanism 27, spindle motor (not shown), and other components are controlled by a controller 10 shown in FIG. 2. Specifically, an NC program stored in the controller 10 is executed as appropriate and an operation controller 11 controls the X-axis feed mechanism 29, the Y-axis feed mechanism 28, the Z-axis feed mechanism 27, the spindle motor (not shown), and other components in accordance with control signals based on the NC program.

Thus, in the machine tool 20, the X-axis feed mechanism 29, the Y-axis feed mechanism 28, the Z-axis feed mechanism 27, the spindle motor (not shown), and other components are driven under control by the controller 10, and thereby the spindle 24 is rotated about the axis thereof and the spindle 24 and the table 26 are relatively moved in a three-dimensional space. Accordingly, when the X-axis feed mechanism 29, the Y-axis feed mechanism 28, the Z-axis feed mechanism 27, the spindle motor (not shown), and other components are driven by the controller 10 in accordance with an NC program stored in the controller 10, a workpiece W placed and fixed on the table 26 is machined as appropriate by a tool T attached to the spindle 24. Note that the tool T used in this embodiment is an end mill.

Further, a display device 12 having a display is connected to the controller 10, and data and the like in the controller 10 can be displayed on the display of the display device 12.

### Natural Frequency Deriving Apparatus

Next, a natural frequency deriving apparatus 1 according to this embodiment is described. The natural frequency deriving apparatus 1 according to this embodiment is, as shown in FIGS. 1 and 2, composed of an accelerometer 5 stuck to an outer peripheral surface of a lower end portion of the spindle head 23, a force detector 6 fixed on the table 26, a detection machining executing part 2, a frequency analysis part 3, and a natural frequency deriving part 4; the detection machining executing part 2, the frequency analysis part 3, and the natural frequency deriving part 4 are incorporated in the controller 10.

The accelerometer 5 detects an acceleration of the lower end portion of the spindle head 23, in other words, an acceleration transmitted from a cutting tool T (hereinafter, simply referred to as “tool T”) attached to the spindle 24. When the workpiece W is cut by the tool T rotating, cutting resistance from the workpiece W causes vibration on the tool T. The accelerometer 5 detects the vibration that is transmitted to the spindle head 23 from the tool T through the spindle 24 (vibration caused by the tool T) and outputs a signal corresponding to the vibration. Note that the accelerometer 5 can output components for two directions: the X-axis direction and the Y-axis direction. Further, a displacement can be detected by second-order integral of an acceleration; therefore, the output signal from the accelerator 5 can be regarded as detection of a displacement of the tool T.

The force detector 6 has a force sensor 6a incorporated therein and is fixed on the table 26; the force sensor 6a detects an external force applied thereon and outputs a signal corresponding to the external force. The workpiece W is mounted on the force detector 6. Accordingly, when the workpiece W is cut by the tool T in this state, a cutting force applied to the workpiece W by the tool T, in other words, a cutting force applied to the tool T as a reaction force of the cutting force applied to the workpiece W is detected by the force sensor 6a, and a signal corresponding to the cutting force is output.

The detection machining executing part 2 is a processing unit that transmits a control signal to the operation controller 11 to cause the operation controller 11 to control the machine tool 20, thereby causing the machine tool 20 to execute a machining operation for deriving a natural frequency of the tool T. Specifically, the detection machining executing part 2 has an NC program stored therein for causing the machine tool 20 to perform the machining operation shown in FIG. 3, and transmits a control signal based on the NC program to the operation controller 11 so as to cause the machine tool 20 to operate.

In the machining operation shown in FIG. 3, for example, an end mill is used as the tool T, and the spindle 24 is rotated in the arrow direction at an initial rotational speed that is set as appropriate (for example, 3300 [min⁻¹]). Depth of cut is set to a value which does not cause chatter (for example, 1 [mm]) and width of cut Ae and feed amount (mm/edge) are set as appropriate. The tool T and the workpiece W are relatively moved in the X-axis direction so as to move them to the position indicated by P₁ and then to the position indicated by P₂, whereby the workpiece W is machined by down cut by the tool T.

In this process, the distance between P₁ and P₂ is equally divided into n sections x₁ to xₙ and the rotational speed of the spindle 24 is increased every section in a sequential stepwise manner. For example, when the rotational speed is to be increased by 10 [min⁻¹] every section and the rotational speed in the section x₁ is 3300 [min⁻¹], the rotational speed in the section x₂ is set to 3310 [min⁻¹] and the rotational speed in the section x₃ is set to 3320 [min⁻¹]. Thus, the rotational speed is increased in increments of 10 [min⁻¹] in a stepwise manner until the section xₙ is reached. Note that, if the feed speed is constant, the sections have the same machining time. Therefore, it is also possible to conceive that the rotational speed is to be increased at intervals of a predetermined machining time.

After the machining in which the tool T and the workpiece W are relatively moved in the X-axis direction in the above-described manner is finished, the tool T and the workpiece W are relatively moved in the Y-axis direction so as to move them to the position indicated by P₃ and then to the position indicated by P₄, whereby the workpiece W is machined by down cut by the tool T.

In this process, similarly to the above, the distance between P₃ and P₄ is equally divided into i sections y₁ to yᵢ and the rotational speed of the spindle 24 is increased every section in a sequential stepwise manner. For example, when the rotational speed is to be increased by 10 [min⁻¹] every section and the rotational speed in the section y₁ is 3300 [min⁻¹], the rotational speed in the section y₂ is set to 3310 [min⁻¹] and the rotational speed in the section y₃ is set to 3320 [min⁻¹]. Thus, the rotational speed is increased in increments of 10 [min⁻¹] in a stepwise manner until the section yᵢ is reached

The detection machining executing part 2 causes the machine tool 20 to execute the above-described machining operation.

While the above-described machining operation is executed by the machine tool 20 under control by the detection machining executing part 2, the frequency analysis part 3 receives signals output from the accelerometer 5 and the force sensor 6a and processes an acceleration signal and a force signal for each section (that is, for each rotational speed of the spindle 24; the same is applied below).

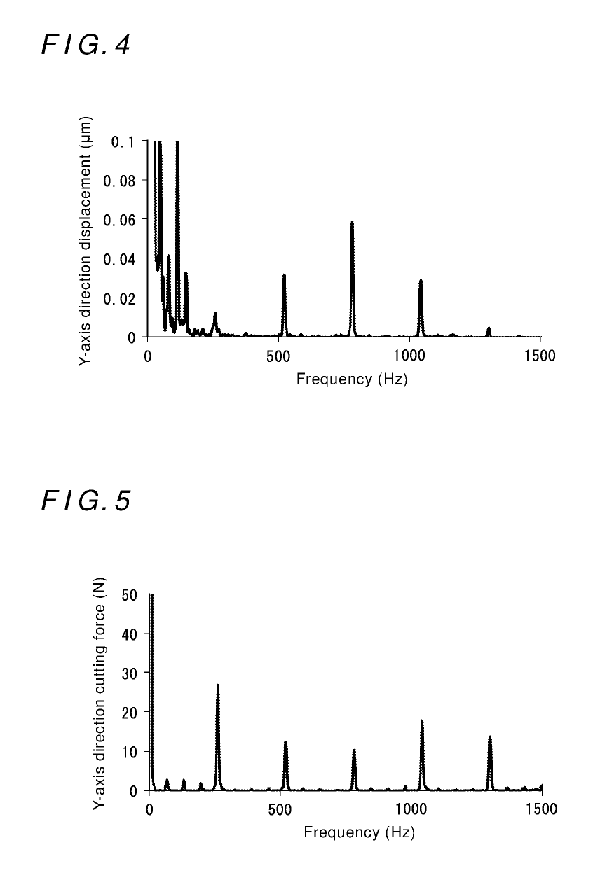

That is, the frequency analysis part 3 performs frequency analysis by FFT on a Y-axis direction vibration component of the acceleration signal for each of the sections x₁ to xₙ, and then performs second-order integration to convert it into a displacement spectrum for each section. A Y-axis direction displacement spectrum for a certain section, which was obtained in the above-described manner, is shown in FIG. 4.

Further, the frequency analysis part 3 also performs frequency analysis by FFT on a Y-axis direction component of the force signal for each of the sections x₁ to xₙ to calculate a cutting force spectrum for each section. A Y-axis direction cutting force spectrum for a certain section, which was obtained in the above-described manner, is shown in FIG. 5.

Similarly, the frequency analysis part 3 performs frequency analysis by FFT on an X-axis direction vibration component of the acceleration signal for each of the sections y₁ to yᵢ, and then performs second-order integration to convert it into a displacement spectrum for each section. Further, the frequency analysis part 3 also performs frequency analysis by FFT on an X-axis direction component of the force signal for each of the sections y₁ to yᵢ to calculate a cutting force spectrum for each section.

Note that the reason why a displacement spectrum and a cutting force spectrum for the Y-axis direction are obtained for each of the sections x₁ to xₙ is that, in down cut in which the feed direction is the X-axis direction, the tool T is displaced with a large amount in the Y-axis direction and the cutting force is large in the Y-axis direction. Similarly, the reason why a displacement spectrum and a cutting force spectrum for the X-axis direction are obtained for each of the sections y₁ to yᵢ is that, in down cut in which the feed direction is the Y-axis direction, the tool T is displaced with a large amount in the X-axis direction and the cutting force is large in the X-axis direction.

In the above-described manner, the frequency analysis part 3 calculates a Y-axis direction displacement spectrum and a Y-axis direction cutting force spectrum for each of the sections x₁ to xₙ and calculates an X-axis direction displacement spectrum and an X-axis direction cutting force spectrum for each of the sections y₁ to yᵢ.

The natural frequency deriving part 4 performs a processing for deriving a natural frequency of the tool T based on the displacement spectra and cutting force spectra obtained by the processing in the frequency analysis part 3.

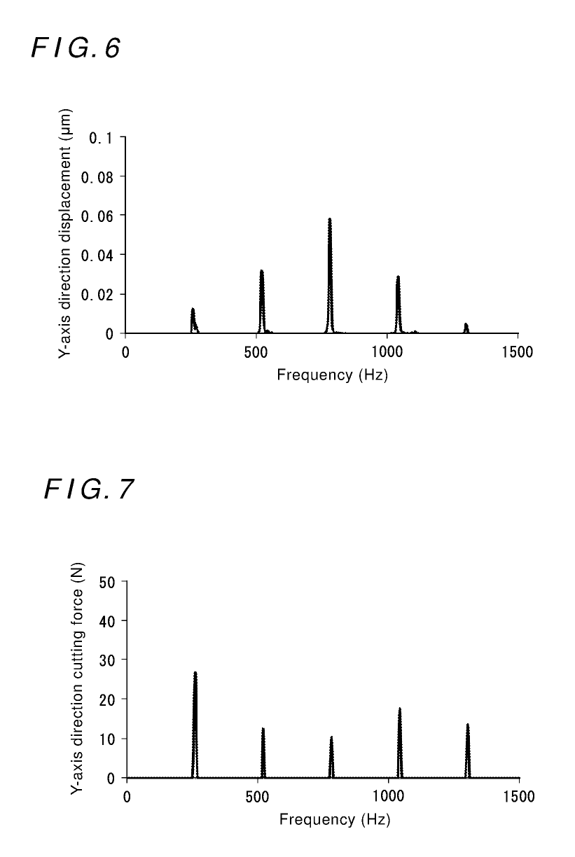

Specifically, the natural frequency deriving part 4 first filters the Y-axis direction displacement spectrum and Y-axis direction cutting force spectrum for each of the sections x₁ to xₙ, which were calculated by the frequency analysis part 3, and the X-axis direction displacement spectrum and X-axis direction cutting force spectrum for each of the sections y₁ to yᵢ, which were calculated by the frequency analysis part 3, to remove noise therefrom. It is known that a frequency showing a peak in the displacement spectrum and the cutting force spectrum is an integer multiple of a frequency when a cutting edge of the tool T is brought into contact with the workpiece W (this frequency is referred to as “cutting edge passing frequency”). Therefore, noise components can be removed by extracting only frequency components in a predetermined width corresponding to integer multiples of the cutting edge passing frequency by filtering. The resultant spectrum after removing noise components from the Y-axis direction displacement spectrum of FIG. 4 is shown in FIG. 6. The resultant spectrum after removing noise components from the Y-axis direction cutting force spectrum of FIG. 5 is shown in FIG. 7. Note that the cutting edge passing frequency can be calculated by the following equation:

cutting edge passing frequency [Hz]=(rotational speed of spindle 24 [min⁻¹]×number of edges)/60 [sec]

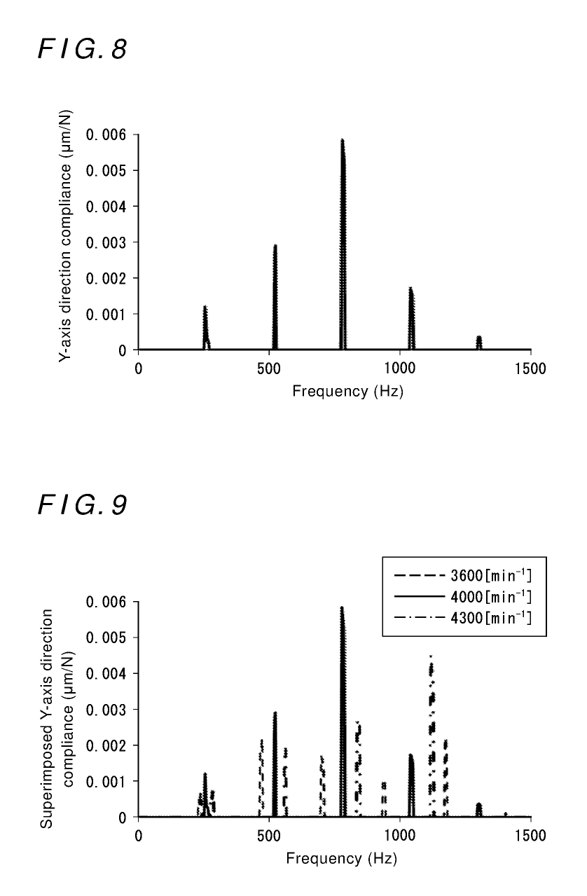

Subsequently, based on the Y-axis direction displacement spectrum and Y-axis direction cutting force spectrum after noise removal for each of the sections x₁ and xₙ and the X-axis direction displacement spectrum and X-axis direction cutting force spectrum after noise removal for each of the sections y₁ to yᵢ, the natural frequency deriving part 4 calculates, for each of the sections x₁ to xₙ and each of the sections y₁ to yᵢ, a compliance spectrum that is obtained by dividing the displacement spectrum by the cutting force spectrum. Note that “compliance” is a ratio between the cutting force as input and the displacement of the tool T as output thereto, and is defined as an input-to-output transfer function. An example of the compliance spectrum obtained in the above-described manner is shown in FIG. 8. FIG. 8 shows a Y-axis direction compliance spectrum for a certain section of the sections x₁ to xₙ.

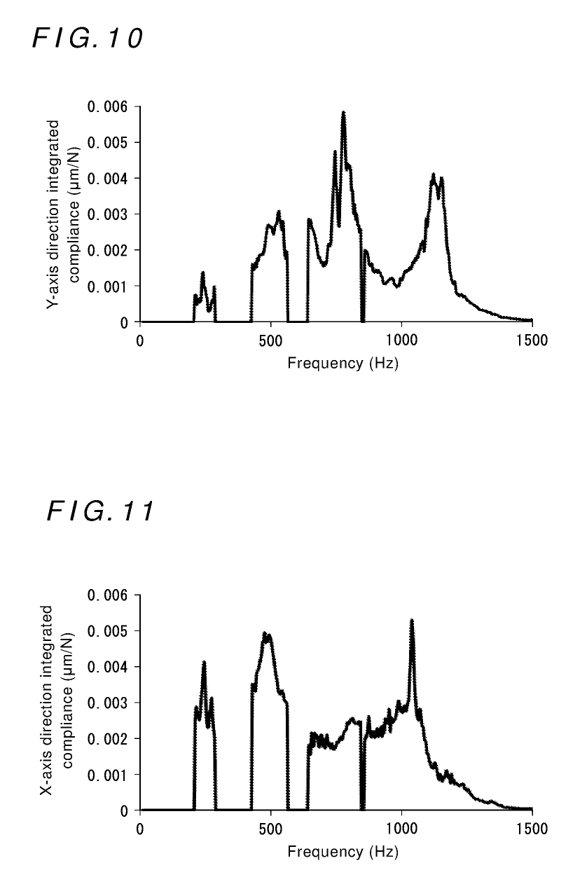

Subsequently, the natural frequency deriving part 4 integrally superimposes the obtained Y-axis direction compliance spectra for the sections x₁ to xₙ to calculate a Y-axis direction integrated compliance spectrum, and integrally superimposes the obtained X-axis direction compliance spectra for the sections y₁ to yᵢ to calculate an X-axis direction integrated compliance spectrum. FIG. 9 shows, as an example, Y-axis direction compliance spectra for a section in which the rotational speed of the spindle 24 is set to 3600 [min⁻¹], a section in which the rotational speed of the spindle 24 is set to 4000 [min⁻¹], and a section in which the rotational speed of the spindle 24 is set to 4300 [min⁻¹] being superimposed. Further, FIG. 10 shows a waveform (Y-axis direction integrated compliance spectrum) obtained by integrally superimposing the Y-axis direction compliance spectra for the sections x₁to xₙ and tracing peaks thereof. Similarly, FIG. 11 shows a waveform (X-axis direction integrated compliance spectrum) obtained by integrally superimposing the X-axis direction compliance spectra for the sections y₁ to yᵢ and tracing peaks thereof.

Subsequently, based on the calculated Y-axis direction integrated compliance spectrum and X-axis direction integrated compliance spectrum, the natural frequency deriving part 4 analyzes each of the integrate compliance spectra to derive, as a natural frequency of the tool T, a frequency showing the largest compliance value. As described above, “compliance” expresses [displacement (=output)/cutting force (=input)]. Therefore, a frequency showing the largest compliance value, that is, a frequency with the largest output to the input can be designated as a natural frequency of the tool T.

Note that the X-axis direction and Y-axis direction displacement spectra and the X-axis direction and Y-axis direction cutting force spectra, which are calculated by the frequency analysis part 3, can be displayed on the display of the display device 12. Similarly, the X-axis direction and Y-axis direction displacement spectra after noise filtering, the X-axis direction and Y-axis direction cutting force spectra after noise filtering, the X-axis direction and Y-axis direction compliance spectra, and the X-axis direction and Y-axis direction integrated compliance spectra, which are calculated by the natural frequency deriving part 4, also can be displayed on the display of the display device 12.

In the natural frequency deriving apparatus 1 according to this embodiment having the above-described configuration, first, the detection machining executing part 2 causes the machine tool 20 to operate so as to cut a workpiece W using the tool T. In this process, the rotational speed of the spindle 24 is increased every section from the section x₁ to the section xₙ in a sequential stepwise manner when the tool T and the workpiece W are moved in the X-axis direction, and the rotational speed of the spindle 24 is increased every section from the section y₁ to the section yᵢ in a sequential stepwise manner when the tool T and the workpiece W are moved in the Y-axis direction.

While machining is being performed in the above-described manner under control by the detection machining executing part 2, based on signals output from the accelerometer 5 and the force sensor 6a, the frequency analysis part 3 calculates a Y-axis direction displacement spectrum and a Y-axis direction cutting force spectrum for each of the sections x₁ to xₙ and calculates an X-axis direction displacement spectrum and an X-axis direction cutting force spectrum for each of the sections y₁ to yᵢ.

Based on the Y-axis direction displacement spectrum and Y-axis direction cutting force spectrum for each of the sections x₁ to xₙ and the X-axis direction displacement spectrum and X-axis direction cutting force spectrum for each of the sections y₁ to yᵢ, which were calculated by the frequency analysis part 3, the natural frequency deriving part 4 calculates, for each of the sections x₁ to xₙ and each of the sections y₁ to yᵢ, a compliance spectrum that is obtained by dividing the displacement spectrum by the cutting force spectrum. Thereafter, the natural frequency deriving part 4 calculates a Y-axis direction integrated compliance spectrum by integrally superimposing the obtained Y-axis direction compliance spectra and calculates an X-axis direction integrated compliance spectrum by integrally superimposing the obtained X-axis direction compliance spectra. Based on the calculated Y-axis direction integrated compliance spectrum and X-axis direction integrated compliance spectrum, the natural frequency deriving part 4 analyzes each of them to derive, as a natural frequency of the tool T, a frequency showing the largest compliance value.

Thus, according to this natural frequency deriving apparatus 1, a workpiece W is machined using an actual tool T whose natural frequency needs to be derived, and a natural frequency of the tool T is derived based on a displacement of the tool T and a cutting force applied to the tool T that are detected during the machining. Therefore, a more accurate natural frequency that takes into account influence of the workpiece W the tool T receives in actual machining can be derived.

Further, an impact hammer, which is used in the conventional method, is not used. Therefore, in deriving a natural frequency of the tool T, the problem of artificial variation does not occur, technical skilled are not required for obtaining appropriate data, and the cumbersome operation of selecting a hammer tip is also not required.

Further, a natural frequency of the tool T is derived for each feed direction. Therefore, a natural frequency of the tool T which better conforms to actual machining situation can be derived.

### Creation of Stability Limit Curve

Next, a manner of creating a stability limit curve using a natural frequency of the tool T derived in the above-described manner is described.

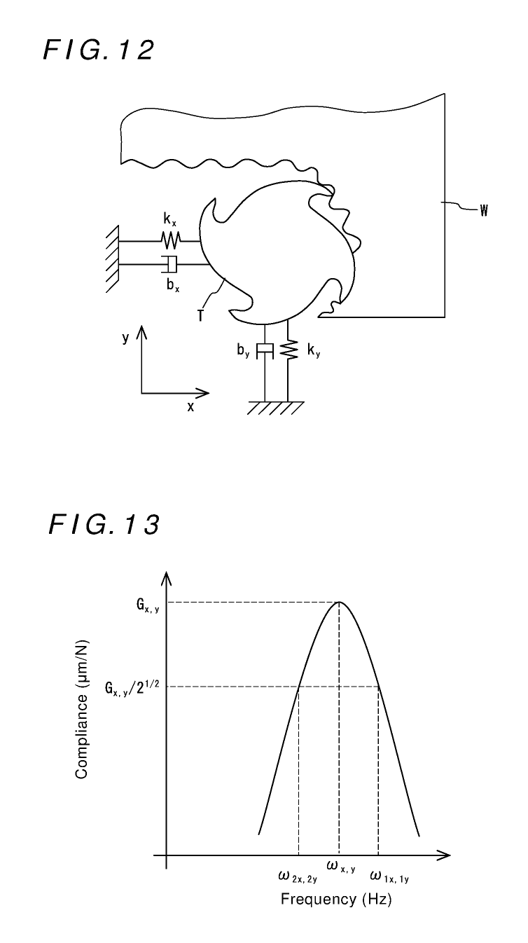

First, basic principles for creating a stability limit curve are explained. The model shown in FIG. 12 is a physical model with two degrees of freedom which is configured to, like the machine tool 20 shown in FIG. 1, relatively move a tool T and a workpiece W in two feed axis directions. Based on this model, conditions which cause regenerative chatter vibration are obtained using an analysis method devised by Y. Altintas.

In this model, the equations of motion for the tool T are represented by the following equations 1 and 2.

x″+2ζₓωₓx′+ωₓ²x=Fₓ/mₓ (Equation 1)

y″+2ζ_{y}ω_{y}y′+ω_{y}²y=F_{y}/m_{y} (Equation 2)

In the equations, ωₓ is a natural frequency [rad/sec] in the X-axis direction of the tool T, ω_{y} is a natural frequency [rad/sec] in the Y-axis direction of the tool T, ζₓ is a damping ratio [%] in the X-axis direction, and ζ_{y} is a damping ratio [%] in the Y-axis direction. Further, mₓ is an equivalent mass [kg] in the X-axis direction, m_{y} is an equivalent mass [kg] in the Y-axis direction, Fₓ is a cutting force [N] applied to the tool T in the X-axis direction, and F_{y} is a cutting force [N] applied to the tool T in the Y-axis direction. Furthermore, x″ and y″ each represent a second-order derivative with respect to time and x′ and Y′ each represent a first-order derivative with respect to time.

The cutting forces Fₓ and F_{y} can be calculated by the following equations 3 and 4, respectively:

Fₓ=−Kₜaₚh(φ)cos(φ)−KᵣKₜaₚh(φ)sin(φ); (Equation 3)

and

F_{y}=+Kₜaₚh(φ)sin(φ)−KᵣKₜaₚh(φ)cos(φ). (Equation 4)

In the equations, h(φ) [m²] is a thickness with which an cutting edge cuts the workpiece W, aₚ [mm] is a depth of cut, Kₜ [N/m²] is a c cutting rigidity in a circumferential direction, and Kᵣ [%] is a specific cutting rigidity in a radial direction.

The cutting forces Fₓ and F_{y} change in accordance with an angle of rotation φ [rad] of the tool T; therefore, the cutting forces Fₓ and F_{y} can be respectively obtained by integrating the cutting forces Fₓ and F_{y} between an angle φₛₜ at which cutting is started and an angle φₑₓ at which the cutting is ended and calculating the average thereof. Further, the angle φₛₜ and the angle φₑₓ can be geometrically determined based on the diameter D [mm] of the tool T, the width of cut Ae [mm], the feed direction, and whether the cutting is upper cut or down cut.

The eigenvalue Λ for the above equations 1 and 2 is represented by the following equation 5:

Λ=−(a₁±(a₁²−4a₀)^{1/2})/2a₀, (Equation 5)

where

a₀=Φₓₓ(iω_{c})Φ_{yy}(iω_{c})(αₓₓα_{yy}−α_{xy}α_{yx})

a₁=αₓₓΦₓₓ(iω_{c})+α_{yy}Φ_{yy}(iω_{c})

Φₓₓ(iω_{c})=1/(mₓ(−ω_{c}²+2iζₓω_{c}ωₓ+ωₓ²))

Φ_{yy}(iω_{c})=1/(m_{y}(−ω_{c}²+2iζ_{y}ω_{c}ω_{y}+ω_{y}²))

αₓₓ=[(cos 2φₑₓ−2Kᵣφₑₓ+Kᵣ sin 2φₑₓ)−(cos 2φₛₜ−2Kᵣφₛₜ+Kᵣ sin 2φₛₜ)]/2

α_{xy}=[(−sin 2φₑₓ−2φₑₓ+Kᵣ cos 2φₑₓ)−(−sin 2φₛₜ−2φₛₜ+Kᵣ cos 2φₛₜ)]/2

α_{yx}=[(−sin 2φₑₓ+2φpₑₓ+Kᵣ cos 2φₑₓ)−(−sin 2φₛₜ+2φₛₜ+Kᵣ cos 2φₛₜ)]/2

α_{yy}=[(−cos 2φₑₓ−2Kᵣφₑₓ−Kᵣ sin 2φₑₓ)−(cos 2φₛₜ−2Kᵣφₛₜ−Kᵣ sin 2φₛₜ)]/2.

In the equations, ω_{c} is a frequency of chatter vibration.

When the real part and the imaginary part of the eigenvalue Λ are represented by Λ_{R} and Λ_{I}, respectively, a depth of cut aₚₗᵢₘ and a spindle rotation speed nₗᵢₘ at a stability limit are represented by the following equations 6 and 7, respectively:

aₚₗᵢₘ=2πΛ_{R}(1+(Λ_{I}/Λ_{R})²)/(NKₜ); (Equation 6)

and

nₗᵢₘ=60ω_{c}/(N(2kπ+π−2 tan⁻¹(Λ_{I}/Λ_{R}))). (Equation 7)

In the equations, N is the number of edges of the tool T and k is an integer.

Using the equations 6 and 7, a stability limit curve can be created by, while changing the values of ω_{c} and k of the equations in an arbitrary manner, calculating the limit depth of cut aₚₗᵢₘ and the spindle rotation speed nₗᵢₘ each time.

By the way, in the above-described natural frequency deriving apparatus 1, the X-axis direction cutting force Fₓ and the Y-axis direction cutting force F_{y} can be detected by the force sensor 6a. Therefore, the cutting rigidity Kₜ [N/m²] and the specific cutting rigidity Kᵣ [%] can be calculated using the equations 3 and 4.

Further, when the X-axis direction natural frequency and Y-axis direction natural frequency of the tool T are represented by ωₓ and ω_{y}, the damping ratios ζₓ and ζ_{y} of the machining system are calculated by, for example, the following equations 8 and 9, respectively:

ζₓ=(ω₁ₓ−ω₂ₓ)/2ωₓ; (Equation 8)

and

ζ_{y}=(ω_{1y}−ω_{2y}/2ω_{y}. (Equation 9)

Note that, as shown in FIG. 13, ω₁ₓ and ω₂ₓ are frequencies corresponding to Gₓ/2^{1/2} on the spectrum waveform when the largest value of the X-axis direction integrated compliance spectrum is Gₓ, and ω_{1y} and ω_{2y} are frequencies corresponding to G_{y}/2^{1/2} on the spectrum waveform when the largest value of the Y-axis direction integrated compliance spectrum is G_{y}.

Further, the equivalent masses mₓ and m_{y} are calculated by the following equations 10 and 11, respectively:

mₓ=1/(2Gₓζₓωₓ²); (Equation 10)

and

m_{y}=1/(2G_{y}ζ_{y}ω_{y}²). (Equation 11)

Thus, the cutting rigidity Kₜ and the specific cutting rigidity Kᵣ are calculated using the equations 3 and 4 based on the cutting forces Fₓ and F_{y} obtained by the natural frequency deriving apparatus 1, and the damping ratios ζₓ and ζ_{y} and the equivalent masses mₓ and m_{y} are calculated using the equations 8, 9, 10, and 11 based on the natural frequencies ωₓ and ω_{y}. Based on the obtained natural frequencies ωₓ and ω_{y}, cutting rigidity Kₜ, specific cutting rigidity Kᵣ, damping ratios ζₓ and ζ_{y}, and equivalent masses mₓ and m_{y}, the real part Λ_{R} and imaginary part Λ_{I} of the eigenvalue Λ are calculated using the equation 5. Thereafter, as described above, using the equations 6 and 7, the limit depth of cut aₚₗᵢₘ and the spindle rotation speed nₗᵢₘ are calculated each time while the values of ω_{c} and k are changed in an arbitrary manner, whereby a stability limit curve can be created.

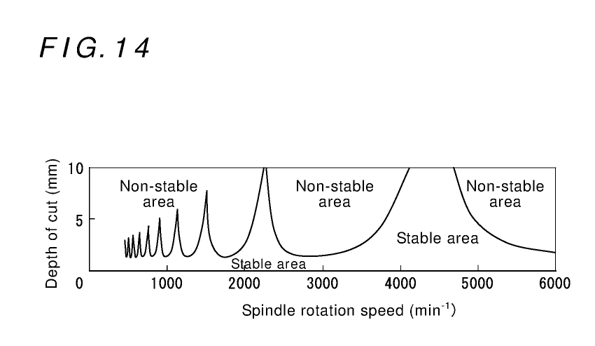

An example of the stability limit curve created in the above-described manner is shown in FIG. 14.

Thus, according to the thus configured stability limit curve creating method, a stability limit curve corresponding to a machine tool 20 having two feed axes: X and Y axes that are perpendicular to a spindle 24 and perpendicular to each other can be created. Further, since this stability limit curve creating method is configured so that, as described above, more accurate natural frequencies which conform to actual machining situation, such as influence of an object to be machined the tool receives in actual machining, are obtained and a stability limit curve is created based on such natural frequencies, an accurate stability limit curve which better conforms to actual machining situation can be created.

Thus, an embodiment of the present disclosure has been described; however, the present disclosure is not limited thereto and can be implemented in other manners.

For example, although a so-called machining center is exemplarily used as the machine tool 20 in the above embodiment, the present disclosure is not limited thereto, and examples of the machine tool to which the present disclosure can be applied include all machine tools capable of machining using a cutting tool which has the possibility of causing regenerative chatter in cutting, such as a lathe and the like.

Further, although an end mill with two degrees of freedom is exemplarily used as the cutting tool T in the above embodiment, the present disclosure is not limited thereto, and the cutting tool to which the present disclosure can be applied may be a cutting tool with one degree of freedom, such as a cutting-off tool or the like.

Further, although the cutting force applied to the tool T is detected by the force sensor 6a in the above embodiment, the present disclosure is not limited thereto and the cutting force may be calculated based on a value of a current supplied to the spindle motor.

Further, the natural frequency deriving part 4 of the natural frequency deriving apparatus 1 in the above embodiment may be configured to, in the step of deriving a natural frequency, derive, as natural frequencies of the cutting tool, at least two frequencies showing a maximal compliance value in decreasing order of the compliance value for each of the X-axis and Y-axis feed directions based on the integrated compliance spectrum for the feed direction. Further, in the creation of a stability limit curve, a configuration is possible in which the damping ratio and the equivalent mass are calculated corresponding to each of the natural frequencies of the cutting tool for each of the feed directions based on the integrated compliance spectrum for the feed direction and the natural frequencies for the feed direction, and a stability limit curve is created corresponding to each of the natural frequencies based on the obtained damping ratios and equivalent masses and the natural frequencies.

In such a configuration, it is possible to create a stability limit curve for each of a plurality of possible natural frequencies of the cutting tool, and setting actual machining conditions with reference to such stability limit curves achieves a more stable machining in which regenerative chatter is more unlikely to occur.

Further, in the above stability limit curve creating method, a configuration is possible in which the damping ratio and the equivalent mass are calculated for each of the feed directions based on the integrated compliance spectrum obtained for the feed direction and the natural frequency of the cutting tool for the feed direction, and a cutting force applied to the cutting tool, or a damping ratio and an equivalent mass, as well as a natural frequency of the cutting tool for a predetermined arbitrary feed direction are estimated based on the obtained damping ratios and equivalent masses for the feed directions and the natural frequencies, and a stability limit curve concerning regenerative chatter of the cutting tool for the predetermined arbitrary feed direction is created.

What is claimed is:

1. A method of deriving a natural frequency of a cutting tool used in machining an object to be machined with a machine tool, comprising:
an actual machining step of, while changing a rotational speed of a spindle of the machine tool in a stepwise manner, machining the object to be machined with the cutting tool by a predetermined distance or for a predetermined period of time at each rotational speed;
a detecting step of, during the actual machining step, detecting a position displacement occurring on the cutting tool and detecting a cutting force applied to the cutting tool;
an analyzing step of performing frequency analysis on displacement data and cutting force data obtained at each rotational speed of the spindle in the detecting step to obtain a displacement spectrum and a cutting force spectrum; and
a deriving step of:
calculating, based on the displacement spectrum and the cutting force spectrum for each rotational speed of the spindle obtained in the analyzing step, a compliance spectrum for each rotational speed by dividing the displacement spectrum by the cutting force spectrum,
calculating an integrated compliance spectrum by superimposing the calculated compliance spectra, and
deriving, as a natural frequency of the cutting tool, a frequency showing a largest compliance value from the calculated integrated compliance spectrum.

2. The method according to claim 1, in which:
the actual machining step is configured to, while changing a rotational speed of the spindle in a stepwise manner, at each rotational speed, machine the object to be machined by a predetermined distance or for a predetermined period of time by relatively moving the cutting tool with respect to the object to be machined through independent operations of a first axis and a second axis as two feed axes perpendicular to the spindle and perpendicular to each other or through a combined operation of the first axis and the second axis so that feed components for directions of the first axis and the second axis are contained;
the detecting step is configured to detect a position displacement occurring on the cutting tool for each of feed directions of the first axis and the second axis at each rotational speed and detect a cutting force applied to the cutting tool at each rotational speed;
the analyzing step is configured to perform frequency analysis on displacement data and cutting force data obtained for each of the feed directions at each rotational speed to obtain a displacement spectrum and a cutting force spectrum; and
the deriving step is configured to,
for each of the feed directions, calculate a compliance spectrum for each rotational speed by dividing the displacement spectrum by the cutting force spectrum and calculate an integrated compliance spectrum by superimposing the calculated compliance spectra,
detect a frequency showing a largest compliance value from each of the calculated integrated compliance spectra, and
derive the two detected frequencies as natural frequencies of the cutting tool for the feed directions.

3. A stability limit curve creating method, comprising:
the steps of claim 1; and
a curve creating step of calculating a damping ratio and an equivalent mass of a machining system including at least the cutting tool and the object to be machined based on the integrated compliance spectrum calculated in the deriving step and the natural frequency of the cutting tool, and creating a stability limit curve concerning regenerative chatter of the cutting tool based on the calculated damping ratio and equivalent mass and the natural frequency.

4. A stability limit curve creating method, comprising:
the steps of claim 1;
the deriving step being configured to derive, as natural frequencies of the cutting tool, at least two frequencies showing a maximal compliance value in decreasing order of the compliance value based on the calculated integrated compliance spectrum; and
a curve creating step of calculating a damping ratio and an equivalent mass of a machining system including at least the cutting tool and the object to be machined corresponding to each of the natural frequencies based on the integrated compliance spectrum calculated in the deriving step and the natural frequencies of the cutting tool, and creating a stability limit curve concerning regenerative chatter of the cutting tool corresponding to each of the natural frequencies based on the calculated damping ratios and equivalent masses and the natural frequencies.

5. A stability limit curve creating method, comprising:
the steps of claim 2; and
a curve creating step of calculating a damping ratio and an equivalent mass of a machining system including at least the cutting tool and the object to be machined for each of the feed directions based on the integrated compliance spectra calculated in the deriving step and the natural frequencies of the cutting tool, and creating a stability limit curve concerning regenerative chatter of the cutting tool for each of the feed directions based on the calculated damping ratios and equivalent masses and the natural frequencies.

6. A stability limit curve creating method, comprising:
the steps of claim 2;
the deriving step being configured to derive, as natural frequencies of the cutting tool, at least two frequencies showing a maximal compliance value in decreasing order of the compliance value for each of the feed directions based on the integrated compliance spectrum calculated for the feed direction; and
a curve creating step of calculating a damping ratio and an equivalent mass of a machining system including at least the cutting tool and the object to be machined corresponding to each of the natural frequencies for each of the feed directions based on the integrated compliance spectrum for the feed direction calculated in the deriving step and the natural frequencies of the cutting tool for the feed direction, and creating a stability limit curve concerning regenerative chatter of the cutting tool corresponding to each of the natural frequencies for each of the feed directions based on the calculated damping ratios and equivalent masses and the natural frequencies.

7. A stability limit curve creating method, comprising:
the steps of claim 2; and
a curve creating step of calculating a damping ratio and an equivalent mass of a machining system including at least the cutting tool and the object to be machined for each of the feed directions based on the integrated compliance spectrum for the feed direction calculated in the deriving step and the natural frequency of the cutting tool for the feed direction, and creating a stability limit curve concerning regenerative chatter of the cutting tool for a predetermined feed direction based on the calculated damping ratios and equivalent masses for the feed directions and the natural frequencies for the feed directions.

8. An apparatus for deriving a natural frequency of a cutting tool used in machining an object to be machined with a machine tool, comprising:
a machining executing part causing the machine tool to execute an operation of, while changing a rotational speed of a spindle of the machine tool in a stepwise manner, machining the object to be machined by a predetermined distance or for a predetermined period of time at each rotational speed;
a displacement detector detecting a position displacement occurring on the cutting tool during the execution of machining by the machine tool;
a cutting force detector detecting a cutting force applied to the cutting tool during the execution of machining by the machine tool;
a frequency analysis part performing frequency analysis on displacement data and cutting force data obtained at each rotational speed of the spindle by the displacement detector and the cutting force detector to obtain a displacement spectrum and a cutting force spectrum;
a natural frequency deriving part,
calculating, based on the displacement spectrum and the cutting force spectrum for each rotational speed of the spindle obtained by the frequency analysis part, a compliance spectrum for each rotational speed by dividing the displacement spectrum by the cutting force spectrum,
calculating an integrated compliance spectrum by superimposing the calculated compliance spectra, and
deriving, as a natural frequency of the cutting tool, a frequency showing a largest compliance value from the calculated integrated compliance spectrum.

9. The apparatus according to claim 8, in which:
the machining executing part is configured to, while changing a rotational speed of the spindle in a stepwise manner, at each rotational speed, machine the object to be machined by a predetermined distance or for a predetermined period of time by moving the cutting tool through independent operations of a first axis and a second axis as two feed axes perpendicular to the spindle and perpendicular to each other or through a combined operation of the first axis and the second axis so that feed components for directions of the first axis and the second axis are contained,
the displacement detector is configured to detect a position displacement occurring on the cutting tool for each of feed directions of the first axis and the second axis at each rotational speed;
the cutting force detector is configured to detect a cutting force applied to the cutting tool at each rotational speed;
the frequency analysis part is configured to perform frequency analysis on displacement data and cutting force data obtained for each of the feed directions at each rotational speed to obtain a displacement spectrum and a cutting force spectrum; and
the natural frequency deriving part is configured to,
for each of the feed directions, calculate a compliance spectrum for each rotational speed by dividing the displacement spectrum by the cutting force spectrum and calculate an integrated compliance spectrum by superimposing the calculated compliance spectra,
detect a frequency showing a largest compliance value from each of the calculated integrated compliance spectra, and
derive a natural frequency of the cutting tool from the two detected frequencies.
